(19) United States
(12) Patent Application Publication
(10) Pub. No.: US 2007/0086479 A1
(43) Pub. Date: Apr. 19, 2007

(54) Techniques to buffer traffic in a communications system

(76) Inventors: Jing Ling, Fremont, CA (US); Jean-Michel Caia, Plymouth, CA (US); Alejandro Lenero Beracoechea, Phoenix, AZ (US)

Correspondence Address: INTEL CORPORATION;C/O INTELLEVATE, LLC, P.O. BOX 52050, MINNEAPOLIS, MN, 55402, US

(21) Appl. No.: 11/359,819

(22) Filed: Feb. 21, 2006

Related U.S. Application Data
(63) Continuation-in-part of application No. 11/241,356, filed on Sep. 30, 2005.

(51) Int. Cl. H04L 12/66

(52) U.S. Cl. 370/463

(57) ABSTRACT

Techniques are described herein that may be used to buffer traffic received at a communications device. For example, a buffer external from a traffic processor may be used to buffer traffic in ingress or egress directions. For example, a bandwidth in each of directions of to and from the buffer may be less than a sum of maximum bandwidths in ingress and egress directions. For example, a single memory interface may be used to communicatively couple the buffer and the traffic processor.

### PRIORITY INFORMATION

This application is a continuation-in-part of U.S. patent application Ser. No. 11/241,356 entitled “Configurable Bandwidth Allocation for Data Channels Accessing a Memory Interface”, filed Sep. 30, 2005, attorney docket no. P22356, and claims the benefit of priority thereof.

### FIELD

The subject matter disclosed herein relates to traffic buffering techniques in a communications system.

### RELATED ART

In a data communication system, traffic may be received at a receiving node from a transmitting node at a peak rate higher than the receiving node can transfer or process the received traffic. As a consequence, overflow of traffic may result at the receiving node. One possible undesirable consequence of overflow is that received traffic is discarded by the receiving node. Buffering may be used at the receiving node to avoid discarding of traffic. Messaging may be used to communicate to one or more transmitting node to reduce the rate at which traffic is transmitted to the receiving node.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 depicts in block diagram form a system, in accordance with some embodiments of the present invention.

FIG. 2 shows an example transceiver in block diagram format, in accordance with some embodiments of the present invention.

FIGS. 3A and 3B show example packet formats that can be used to buffer traffic, in accordance with some embodiments of the present invention.

FIG. 4 depicts an example flow diagram, in accordance with some embodiments of the present invention.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

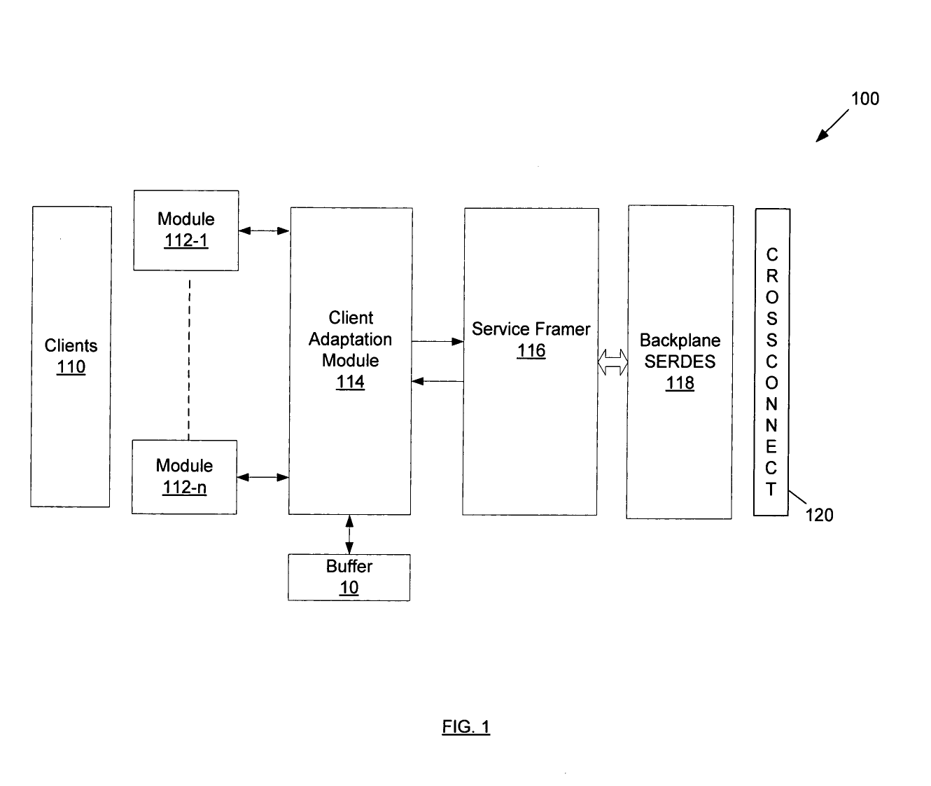

FIG. 1 depicts an example system in which some embodiments of the present invention may be used. The system of FIG. 1 may include a transceiver system 100 capable to receive and transmit optical or other types of signals. Such a device may be useful in combining multiple client signals and/or channels for transmission over a communications network. The system architecture of FIG. 1 also allows signals of different data sizes and protocols to be aggregated into a multiple service framed communications protocol, such as but not limited to Synchronous Optical Network (SONET), Synchronous Digital Hierarchy (SDH), Plesiosynchronous Digital Hierarchy (PDH), or Optical Transport Networks (OTN). For example, different types of traffic (such as but not limited to, Gigabit Ethernet and Fibre Channel) may be transmitted over long distance using optical signal standards, or any of a variety of other types using different data rates and different protocols. Fibre Channel is described for example at ANSI INCITS 230-1994 (R1999). Ethernet standard is described for example at IEEE Std. 802.3-2002. As used herein, the term “traffic” may include any packet or frame or other format of information with a header and payload portions formed in accordance with any protocol specification.

In system 100, a plurality of clients 110 are connected using Small Form Factor Pluggable (SFP) or 10 Gigabit Small Form Factor Pluggable (XFP) modules 112-1 to 112-n, although other types of modules may be used. SFP is described in Small Form-factor Pluggable (SFP) Transceiver MultiSource Agreement (MSA) (2000), as well as revisions thereof. XFP is described in 10 Gigabit Small Form Factor Pluggable Module, Revision 3.1 (2003), as well as revisions thereof. SFP and XFP modules may operate as optical transceivers independent of any particular protocol. However, protocol-specific connectors or connectors for other types of physical channels may be used instead. For example, copper SFP modules may be used. In some embodiments, modules 112-1 to 112-n may translate optical signals into electrical signals.

Modules 112-1 to 112-n may be coupled to a client adaptation module 114. Client adaptation module 114 may encode or process at least two types of traffic in accordance with relevant standards. For example, client adaptation module 114 may convert 8 B/10 B streams into packets and vice versa.

In some embodiments, buffer 10 may include the capability to buffer and provide at least two types of traffic by use of a single memory interface to and from the buffer. Each of the input effective (usable) bandwidth to the memory interface and the output effective bandwidth from the memory interface may be less than a sum of total bandwidths in the ingress and egress directions and each effective bandwidth may be greater than or equal to the bandwidth in a single (ingress or egress) direction.

For example, buffer 10 may be communicatively coupled to adaptation module 114 using the single memory interface. For example, buffer 10 may be a separate physical device from the logic used to implement client adaptation module 114. For example, buffer 10 may store Ethernet or Fibre Channel traffic types, although other types of traffic may be stored. For example, buffer 10 may store near-end and/or far-end traffic. For example, near-end and far-end traffic may include traffic having destinations other than system 100. In some cases, far-end traffic may have a destination that is further from the transmitter than that of near-end traffic. For example, for near-end traffic, a transmitter-to-receiver distance may be approximately 5-100 km. For example, for far-end traffic, a transmitter-to-receiver distance may be approximately 100 to 10,000 km. For example, far end traffic may refer to the traffic being carried over a Wide Area Network (WAN), whereas near-end traffic may refer to the traffic sent or received from the Local Area Network (LAN) or Storage Area Network (SAN) interfacing directly with the client adaptation module. In some embodiments, near-end traffic may be received in the ingress direction whereas far-end traffic may be received in the egress direction.

In some embodiments, buffering of traffic in either ingress or egress directions may be performed by a memory device within or among a physical device used to implement client adaptation module 114. For example, traffic transmitted a shorter distance (e.g., near-end traffic) may be buffered by such memory device.

Client adaptation module 114 may be coupled to a service framer 116 using, for example, a System Packet Interface (SPI) compatible interface. Service framer 116 may receive at least SONET, SDH, PDH, or OTN frames and unpack payloads of such frames into packets or other contents (such as but not limited to Generic Framing Procedure (GFP) packet, Fibre Channel, or Ethernet). In addition, service framer 116 may frame packets or other contents such as but not limited to Generic Framing Procedure (GFP) packet, Fibre Channel, or Ethernet into SONET, SDH, PDH, or OTN frames. Service framer 116 may also be directly connected to optical fiber or cables towards a WAN. Service framer 116 may be coupled with a Synchronous Transport Signal (STS) cross connect 120 through a backplane Serializer Deserializer (SERDES) 118.

For example, SERDES 118 may be TFI-5 compatible and may convert SFI-4 format signals into TFI-5 format and vice versa, although other standards may be used. Cross connect 120 may perform switching or routing of packets or frames. Cross connect 120 may transfer packets or frames among line cards or other devices. For example, line cards may include (but are not limited to) any of SONET/SDH add-drop multiplexer, a Fibre Channel compatible line input, an Ethernet line input, a SONET/SDH compatible transceiver.

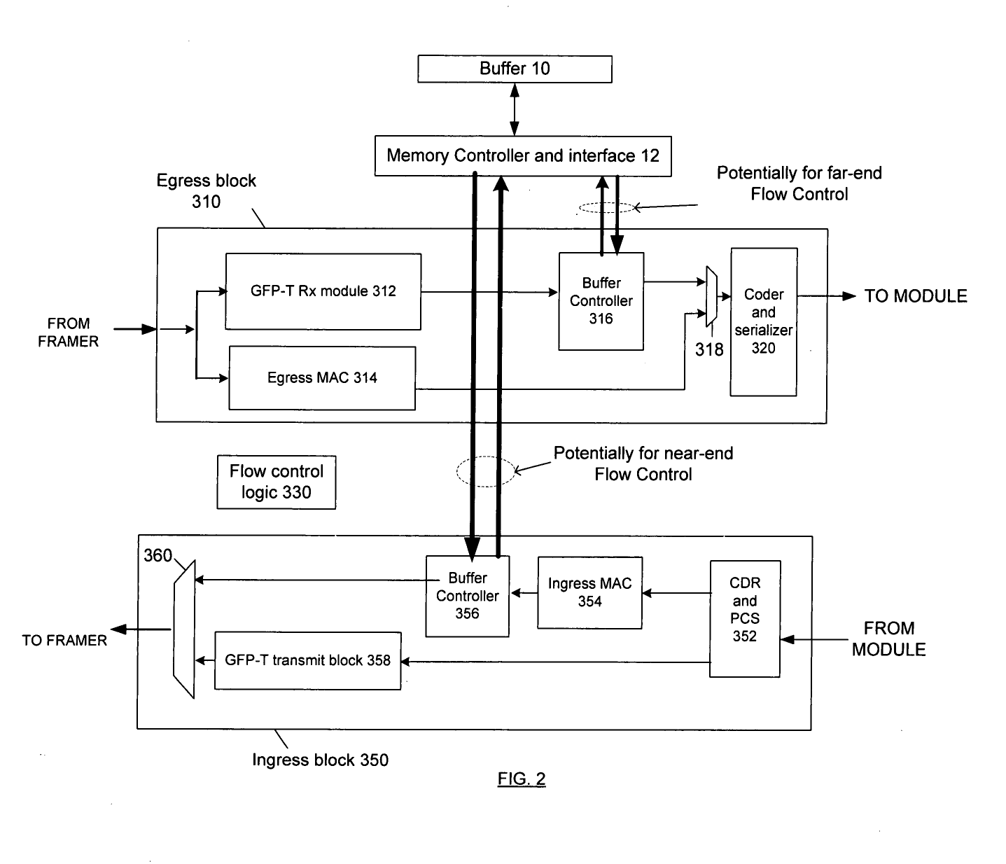

FIG. 2 shows an example transceiver in block diagram format, in accordance with some embodiments of the present invention. For example, the transceiver may include buffer 10, memory controller 12, egress block 310, flow control logic 330, and ingress block 350.

Buffer 10 may store traffic from egress block 310 and ingress block 350. For example, if egress block 310 receives traffic at a peak rate higher than it is capable of transferring or processing the traffic, then some traffic may be buffered in buffer 10. Similarly, if ingress block 350 receives traffic at a peak rate higher than it is capable of transferring or processing the traffic, then some traffic may be buffered in buffer 10. Buffer 10 may store and release traffic in a first-in-first out manner. For example, buffer 10 may be implemented as one or more Synchronous Dynamic Random Access Memory (SDRAM) devices, although other types of memory may be used. For example, buffer 10 may include multiple first-in-first-out (FIFOs) buffers, where each FIFO is available of use for each type of traffic (e.g., Fibre Channel or Ethernet). Memory controller and interface 12 may be capable to coordinate receipt and transfer of traffic between buffer 10 and egress block 310 and/or ingress block 350. A single memory interface may be used to communicatively couple buffer 10 and egress block 310 and/or ingress block 350.

For example, if a traffic protocol does not specify a need to buffer, no buffering may take place by use of buffer 10. In some embodiments, for a port, buffering in buffer 10 may occur for a single direction of traffic (i.e., near-end or far-end). Buffering by use of buffer 10 in only one direction for a port may reduce total transfer rates to and from buffer 10. For example, in some drafts of the Ethernet standard, buffering for far-end traffic is not stated as being required. For example, for Ethernet traffic, buffer 10 may be used to buffer near-end traffic. For example, for Fibre Channel traffic, buffer 10 may be used to buffer far-end traffic. Buffering for near-end Fibre Channel traffic may take place by use of an internal buffer. For example, if each of egress and ingress directions transport 8 Gbps, and 6 Gbps of Fibre Channel traffic is transported in the egress direction and 2 Gbps of Ethernet traffic is transported in the ingress direction and both are to be buffered, then each of the input bandwidth of the memory interface and the output bandwidth from the memory interface may be 8 Gbps as opposed to 16 Gbps. In some embodiments, for near-end flow control, traffic buffered in buffer 10 may include data from Ethernet packets, whereas, for far-end flow control, traffic buffered in buffer 10 may include data of decoded Fibre Channel traffic, although other types of traffic, directions, or travel distances of traffic may be buffered.

For example, egress block 310 may include a GFP-T receive (Rx) client adaptation module 312, egress media access controller (MAC) 314, buffer controller 316, multiplexer 318, and coder and serializer 320. Egress block 310 may be capable to encode signals for transmission in accordance with various standards. Egress block 310 may be capable to transmit Ethernet or Fibre Channel types of traffic in compliance with standards such as but not limited to FC-BB-3_SONET and Ethernet. A working draft of the emerging FC-BB-3_SONET standard is described for example at American National Standard for Information Technology, Fibre Channel Backbone—3 (FC-BB-3) (2005). Egress block 310 may be used to support multiple physical ports.

Signals may be provided to egress block 310 from a source such as but not limited to a service framer. For example, a framer such as but not limited to service framer 116 may provide the Fibre Channel traffic to GFP-T Rx module 312. GFP-T Rx module 312 may be capable to receive Fibre Channel traffic and at least perform 64 B/65 B decoding and N times superblocks disassembly on the received traffic in accordance with Fibre Channel standards.

Egress MAC 314 may be capable to generate Ethernet compliant frames from traffic and perform performance monitoring in accordance with Ethernet standards. For example, a framer such as but not limited to service framer 116 may provide the Ethernet traffic to egress MAC 314.

Buffer controller 316 may control routing of data of decoded Fibre Channel traffic between buffer 10 and egress block 310, although other types of traffic and content may be controlled. For example, flow control buffer controller 316 may control whether data of decoded Fibre Channel traffic from GFP-T Rx module 312 is routed to coder and serializer 320 or to buffer 10. In addition, buffer controller 316 may control whether data of decoded Fibre Channel traffic is provided from buffer 10 or from GFP-T Rx module 312 for transmission through an egress port. For example, buffer controller 316 may transfer data of decoded Fibre Channel traffic from buffer 10 to multiplexer 318 if data of decoded Fibre Channel traffic is available in buffer 10. If data of decoded Fibre Channel traffic is not available from buffer 10, buffer controller 316 may transfer data of decoded Fibre Channel traffic from GFP-T Rx module 312 to multiplexer 318.

For example, in some embodiments, the routing of Fibre Channel traffic to coder and serializer 320 may occur based on a credit based scheme described for example in ANSI INCITS 230-1994 (R1999), although routing of Fibre Channel traffic to coder and serializer 320 may occur based on other schemes. In some embodiments, decisions of when to route traffic from or to buffer 10 may be made by either or a combination of buffer controller 316 and memory controller and interface 12.

Multiplexer 318 may selectively transfer one of multiple types or flows of traffic to coder and serializer 320. For example, at least data of decoded Fibre Channel traffic and Ethernet traffic may be provided to multiplexer 318.

Coder and serializer 320 may perform coding in accordance with physical coding sublayer (PCS) as defined at least in IEEE 802.3 (2002) (and revisions thereof) as well as 8 B/10 B coding as defined in IEEE 802.3 (2002) (and revisions thereof), and serializing. Signals from coder and serializer 320 may be provided to a module such as but not limited to an XFP or SFP module for transmission to an optical or other type of network.

Referring next to ingress block 350 of FIG. 2. Some implementations of ingress block 350 may include clock and data recovery (CDR) and physical coding sublayer (PCS) block 352, ingress MAC 354, buffer controller 356, GFP-T transmit block 358, and multiplexer 360. Ingress block 350 may be capable of processing received traffic in accordance with relevant standards. For example, ingress block 350 may be capable of processing Ethernet or Fibre Channel types of traffic compliant with standards such as but not limited to FC-BB-3_SONET and Ethernet. Ingress block 350 may be used to support multiple physical ports.

Signals to CDR and PCS block 352 may be provided from a module such as but not limited to an XFP or SFP module after receipt from an optical or other type of network. CDR and PCS block 352 may at least perform 8 b/10 b decoding and performance monitoring in accordance with IEEE 802.3 (2002) (and revisions thereof). Ingress MAC 354 may at least perform Remote Network Monitoring (RMON) in accordance with IEEE 802.3 (2002) (and revisions thereof).

Buffer controller 356 may control routing of Ethernet traffic between buffer 10 and ingress block 350, although other types of traffic may be controlled. For example, buffer controller 356 may determine whether to route Ethernet traffic from ingress MAC 354 to multiplexer 360 or to buffer 10. In addition, buffer controller 356 may determine whether to route Ethernet traffic from ingress MAC 354 or from buffer 10 for transfer to multiplexer 360 based on a constant output rate or other schemes. For example, buffer controller 356 may transfer traffic from buffer 10 to multiplexer 360 if Ethernet traffic is available in buffer 10. If Ethernet traffic is not available from buffer 10, buffer controller 356 may transfer Ethernet traffic from ingress MAC 354 to multiplexer 360. In some embodiments, decisions of when to route Ethernet traffic from or to buffer 10 may be made by either or a combination of buffer controller 356 and memory controller and interface 12.

GFP-T transmit block 358 may at least perform 64 B/65 B encoding as well as N times Superblocks assembly for transmission of Fiber Channel traffic in accordance with Fibre Channel standards.

Multiplexer 360 may selectively transfer one of multiple types or flows of traffic for transmission. For example, Fibre Channel and Ethernet traffic may be provided to multiplexer 360. For example, multiplexer 360 may selectively transfer traffic to a framer such as but not limited to a service framer.

Flow control logic 330 may be capable to generate rate pacing messages to transmitters of traffic. In some embodiments, flow control logic 330 may generate messages to indicate whether a transmitter of traffic is to pause or resume transmission of traffic. For example, flow control logic 330 may examine a storage level of buffer 10 to determine whether to send flow control messages. For example, if a level of buffered traffic is considered too high, then messages indicating pause or slow traffic transmission may be made. For example, if a level of buffered traffic is considered too low, then messages indicating resume traffic transmission may be made.

To control the rate of receipt of Ethernet traffic, flow control logic 330 may insert one or more messages into a path in egress block 310 to inform a transmitter of Ethernet traffic to slow down transmission. To pause transmission of Fibre Channel traffic, flow control logic 330 may transmit a ASFC_PAUSE message through egress block 310 to a transmitter of Fibre Channel traffic. To request transmission of Fibre Channel traffic to resume, flow control logic 330 may transmit a ASFC_RESUME message through egress block 310 to the transmitter of Fibre Channel traffic. Other flow control messages may be used.

In some embodiments, although not depicted, either or both of egress block 310 and ingress block 350 may be capable to buffer traffic that is to be transmitted over a relatively shorter distance than that buffered in buffer 10.

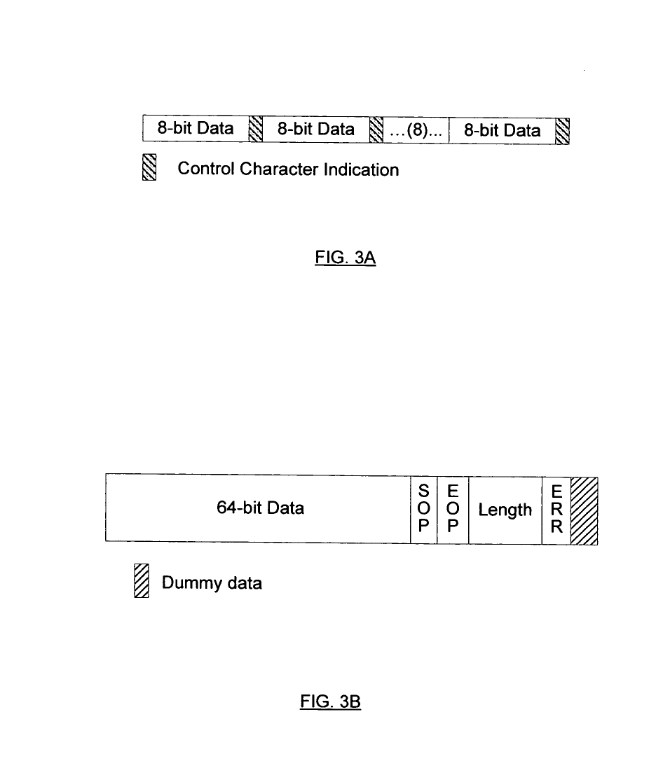

FIG. 3A shows an example format for buffered data contents from decoded Fibre Channel traffic, in accordance with some embodiments. Decoded Fibre Channel traffic may be data decoded from 64 B/65 B encoding (for GFP-T) composed of a data byte (8-bit) and one bit for control character indication (to indicate if the corresponding data byte is a control character or K character, as specified in Fibre Channel standard). Thus, for every 64 bits of data, 8 additional control bits may be added.

FIG. 3B shows an example of packet formats for buffered data contents from Ethernet packets, in accordance with some embodiments. For data from buffered Ethernet packets, in order to determine the packet boundary, control information may be included with the buffered packet. In one embodiment, for a 64-bit word, the following fields may be added: 1 bit start-of-packet (SOP) indication, 1 bit end-of-packet (EOP) indication, 3 bits for word length (in terms of bytes), and 1 bit for packet error condition. Accordingly, there may be 6 bits for control information for every 64 bits of data, although other numbers may be used. In some cases, 2 bits of dummy data may be added. When accessing a buffer such as buffer 10, to simplify the data structure, 8 bits may be used to store control information for every 64 bits of data. For at least Ethernet and Fibre Channel types of traffic, the path width of an interface to and from buffer 10 may be set at 72 bits, although other widths may be used.

For example, if a total bandwidth of client traffic is 8 Gbps in a direction, it is possible to mix different types of client traffic, as long as the total bandwidth in the direction does not exceed 8 Gbps. For example, three 1 Gbps Ethernet channels may be combined with one 1 Gbps Fibre Channel and two 2 Gbps Fibre Channel. If 25% of the 8 Gbps total bandwidth is used for Gigabit Ethernet clients, near-end flow control is to be used for the 2 Gbps channels. The remaining 75% of the total bandwidth will be available for Fibre Channel traffic, which may use far-end flow control for the 6 Gbps channels.

Some embodiments permit modification of the channel bandwidth that is accessing an external buffer by changing the configuration of the channel bandwidth. In the example in the preceding paragraph, a look up table may be used that may include 2ⁿ partitions (where n>1). A partition may be proportional to a portion of the maximum bandwidth rate. For example, 1 partition may correspond to 1 Gbps. In the described example for a maximum bandwidth of 8 Gbps, n=3, so there are 8 partitions. Each partition may correspond to a reserved space within the external buffer and may correspond to one SDRAM page, although other types of memory may be used. The SDRAM page size may be limited by the size of the SDRAM and the number of partitions defined for it. The memory space associated with a channel may depend on the memory size and the number of partitions that are assigned to the channel. A channel, however, may be assigned to as many partitions as needed to fill the channel or as many partitions as desired based on other system design considerations. Each partition may be linked to any channel by the configuration of the look-up table.

An example of a look up table is provided in Table 1. Table 1 associates each partition with a communications channel. Each channel may have the or different bandwidth requirements.

TABLE 1
Partition and direction association to data channel

| Partition | Channel ID | Direction |
|---|---|---|
| 0 | 0 | 1 |
| 1 | 0 | 1 |
| 2 | 1 | 0 |
| 3 | 2 | 0 |
| 4 | 3 | 1 |
| 5 | 4 | 1 |
| 6 | 3 | 1 |
| 7 | 4 | 1 |

In the example of Table 1, “Partition” may represent ⅛ of the total memory bandwidth (and potentially ⅛ of the total memory space). For example, the bandwidth allocation to the direction may be applied for both traffic transferred to the external buffer and from the external buffer. Each unique Channel ID represents a different data channel. For example, Channel ID may represent a unique channel and may correspond to Fibre Channel or Ethernet traffic, although more types of traffic and other types of traffic may be supported. In Table 1, the value of “Direction” may indicate if an ingress or an egress channel is assigned to the partition. For example, Direction=0 means ingress or near-end flow control whereas Direction=1 means egress or far-end flow control.

For example, memory controller and interface 12, buffer controller 316, and/or buffer controller 356 may use the table to allocate bandwidth assigned to transfer buffered traffic between buffer 10 and egress block 310 and/or ingress block 350.

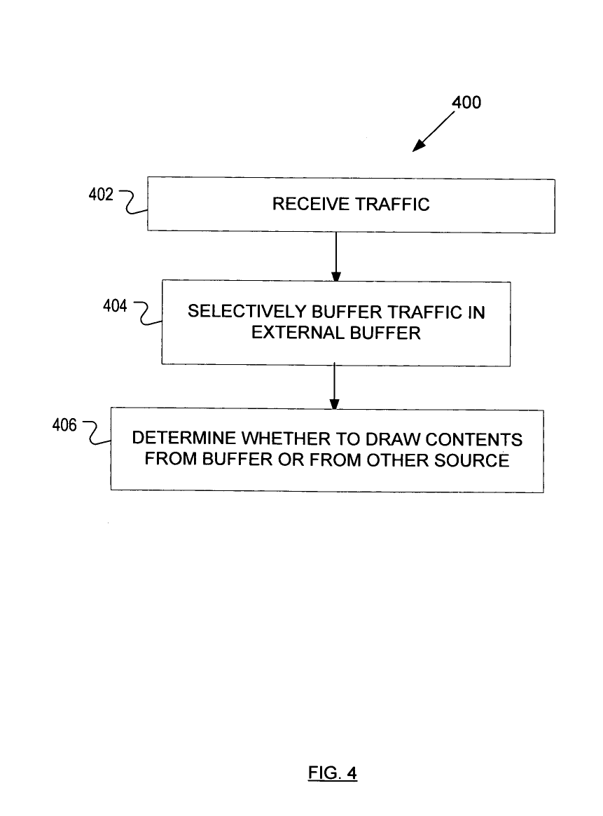

FIG. 4 depicts an example flow diagram in accordance with some embodiments of the present invention. In block 402, a channel block may receive traffic. For example, the channel block may be (but is not limited to) an ingress or egress block described with respect to FIG. 2. For example, the traffic may be any of multiple types of traffic including but not limited to Ethernet and Fibre Channel.

In block 404, the channel block may selectively buffer traffic in an external buffer. For example, the buffer may correspond to (but is not limited to) buffer 10 described with respect to FIG. 2. For example, if the channel receives traffic at a rate higher than it is permitted to transfer the traffic, then some traffic may be transferred to a buffer. Some embodiments include use of a single memory interface to one or more memory devices capable to store at least two types of traffic at least in the event of potential overflow at a channel block. For example, for near-end flow control, buffered traffic may include data from Ethernet packets, whereas, for far-end flow control, buffered traffic may include data of decoded Fibre Channel traffic, although other types of traffic, directions, or travel distances of traffic may be buffered. In some embodiments, each of the effective input bandwidth to the memory interface and the effective output bandwidth from the memory interface may be less than a sum of total bandwidths in the ingress and egress directions and each effective bandwidth may be greater or equal to the bandwidth in a single (ingress or egress) direction.

In block 406, the channel block may determine whether to draw contents from a buffer or from another source. For example, if traffic is available in the external buffer, then traffic from the buffer may be provided for transfer from the channel block. Otherwise, traffic from another source may be provided. For example, other sources may include but are not limited to modules such as GFP-T Rx module 312 or ingress MAC 354. For example, if the channel block is an egress block, then buffered traffic may be data of decoded Fibre Channel traffic. For example, if the channel block is an ingress block, then buffered traffic may be Ethernet traffic.

Embodiments of the present invention may be implemented as any or a combination of: one or more microchips or integrated circuits interconnected using a motherboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments of the present invention may also be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

The drawings and the forgoing description gave examples of the present invention. Although depicted as a number of disparate functional items, those skilled in the art will appreciate that one or more of such elements may well be combined into single functional elements. Alternatively, certain elements may be split into multiple functional elements. Elements from one embodiment may be added to another embodiment. For example, orders of processes described herein may be changed and are not limited to the manner described herein. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. An apparatus comprising:
a memory device capable to store at least two types of traffic;
an ingress channel logic capable to process received traffic in accordance with one or more protocols; and
an egress channel logic capable to process received traffic in accordance with one or more protocols, wherein
an effective bandwidth in each of directions of to and from the memory device is less than a sum of maximum bandwidths in ingress and egress directions and each effective bandwidth is at least equal to the bandwidth in either the ingress or the egress direction.

2. The apparatus of claim 1, wherein traffic stored in the memory device includes control information and wherein multiple types of traffic transmitted to and from the memory device are of a same bit width.

3. The apparatus of claim 1, further comprising logic capable to determine a rate allocated for at least storing ingress and egress directions of traffic into the memory device.

4. The apparatus of claim 1, further comprising logic capable to determine a rate allocated for at least retrieving ingress and egress directions of traffic from the memory device.

5. The apparatus of claim 3, wherein the logic includes use of a table to allocate at least one rate.

6. The apparatus of claim 4, wherein the logic includes use of a table to allocate at least one rate.

7. The apparatus of claim 1, wherein the memory device includes one or more Synchronous Dynamic Random Access Memory devices.

8. The apparatus of claim 1, wherein the memory device is capable to store near-end Ethernet packets and far-end Fibre Channel traffic.

9. The apparatus of claim 1, wherein a single interface is capable for use to communicatively couple the memory device to the ingress channel logic and the egress channel logic.

10. A method comprising:
receiving traffic in one or more of an ingress direction and egress direction;
selectively storing a portion of received traffic in a buffer, wherein at least two types of traffic are capable to be stored and wherein an effective bandwidth in each of directions of to and from the buffer is less than a sum of maximum bandwidths in ingress and egress directions and each effective bandwidth is at least equal to the bandwidth in either the ingress or the egress direction; and
selectively releasing traffic from the buffer in response to availability of traffic in the buffer.

11. The method of claim 10, wherein traffic stored in the buffer includes control information and wherein multiple types of traffic transmitted to and from the buffer are of a same bit width.

12. The method of claim 10, further comprising determining a rate allocated for at least storing ingress and egress directions of traffic into the buffer in part by using a table.

13. The method of claim 10, further comprising determining a rate allocated for at least retrieving ingress and egress directions of traffic from the buffer in part by using a table.

14. The method of claim 10, wherein the buffer is capable to store near-end Ethernet packets and far-end Fibre Channel traffic.

15. The method of claim 10, wherein a single interface is capable for use to transmit to be stored by the buffer and receive traffic buffered by the buffer.

16. A system comprising:
a cross connect;
a framer communicatively coupled to the cross connect; and
logic communicatively coupled to the framer capable to store traffic, wherein the logic comprises:
a memory device capable to store at least two types of traffic,
an ingress channel logic capable to process received traffic in accordance with one or more protocols, and
an egress channel logic capable to process received traffic in accordance with one or more protocols, wherein an effective bandwidth in each of directions of to and from the memory device is less than a sum of maximum bandwidths in ingress and egress directions and each effective bandwidth is at least equal to the bandwidth in either the ingress or the egress direction.

17. The system of claim 16, wherein traffic stored in the memory device includes control information and wherein multiple types of traffic transmitted to and from the memory device are of a same bit width.

18. The system of claim 16, further comprising logic capable to determine a rate allocated for at least storing ingress and egress directions of traffic into the memory device in part by use a table.

19. The system of claim 16, further comprising logic capable to determine a rate allocated for at least retrieving ingress and egress directions of traffic from the memory device in part by use a table.

20. The system of claim 16, wherein a single interface is capable for use to communicatively couple the memory device to the ingress channel logic and the egress channel logic.
